(19) United States
(12) Patent Application Publication
(10) Pub. No.: US 2005/0259358 A1
(43) Pub. Date: Nov. 24, 2005

(54) Magnetic head device and magnetic recording/reproducing apparatus

(76) Inventor: Tadashi Ozue, Kanagawa (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 11/130,321

(22) Filed: May 16, 2005

(30) Foreign Application Priority Data
May 18, 2004 (JP) 2004-148127

(51) Int. Cl. G11B 5/29

(52) U.S. Cl. 360/129

(57) ABSTRACT

The present invention provides a magnetic head device which records magnetic signals simultaneously through a plurality of thin film magnetic heads into a plurality of tracks laid in parallel with a running direction of a magnetic tape. The magnetic head device includes m-pieces of multi-heads spaced from each other by predetermined intervals in a widthwise direction normal to a recording direction of the magnetic tape, each multi-head having n-pieces of the thin film magnetic heads, in which the n-pieces of thin film magnetic heads are arranged adjacent to each other so that a pair of magnetic poles of which are shifted on a head surface of each of the multi-heads in the widthwise direction and the running direction of the magnetic tape.

### CROSS REFERENCES TO RELATED APPLICATIONS

The present document contains subject matter related to Japanese Patent Application JP 2004-148127 filed in the Japanese Patent Office on May 18, 2004, the entire contents of which being incorporated herein by reference.

### BACKGROUND OF THE INVENTION

1. Field of the Invention

The present invention relates to a magnetic head device and a magnetic recording/reproducing apparatus equipped therewith, capable of recording magnetic signals simultaneously through a plurality of thin film magnetic heads into a plurality of tracks laid in parallel with a running direction of a magnetic tape, and in particular to a magnetic head device and a magnetic recording/reproducing apparatus equipped therewith, configured as continuously recording magnetic signals to a plurality of recording channels through multi-heads.

2. Description of Related Art

Magnetic recording head generally includes a first magnetic core layer (magnetic pole) and a second magnetic core layer, both of which composed of a magnetic material, and a coil inducing a magnetic field to two these magnetic core layers, wherein the coil produces leakage magnetic field between end portions of two magnetic core layers. Magnetic signals applied to the coil can be recorded by allowing a magnetic recording medium such as a magnetic tape to travel relative to the magnetic recording head, while keeping a state in contact with, or in proximity to two magnetic core layers.

In recent recording technology aimed at raising recording density, there are demands on narrower tracks, which means reduction in widthwise dimension of recording tracks formed on magnetic recording media, and on adoption of multi-track head. Reduction in widthwise dimension of a magnetic core layer (magnetic pole) of a magnetic head is required to realize the narrower tracks. A currently practiced technology is such as fabricating all portions of the magnetic recording head, including a core, a coil, a gap and an insulating layer, by the thin film formation technique and the photolithographic technique. There are proposed a so-called helical scan system and linear tape system as a recording/reproducing system aimed at realizing larger storage capacity and higher transfer rate, both of which having been already put into practical use.

The helical scan system adopted to VTR (video tape recorder) and DAT (digital audio tape) recorder, for example, is such as using magnetic heads mounted on a drum which rotates at a high speed, allowing a magnetic tape to contact under sliding with the drum, to thereby effect recording/reproduction in an oblique direction on the magnetic tape. This has already been put into practical use in a form of multi-track system.

Japanese Patent Application Publication (KOKAI) 2002-216313, paragraphs [0011]-[0017], discloses a technique of increasing recoding density by making the track pitch densely, through adoption of a multi-head configuration of thin film magnetic recording heads in the helical scan system. In linear scanning of the linear tape system, a linear relative motion is generally established between magnetic heads and a magnetic tape, and this results in formation of a large number of tracks on the magnetic tape, so that every track on the magnetic tape in this case is formed so as to be physically adjacent to each other. In a typical case of multi-track recording, the magnetic tape moves across the magnetic head during reproducing or recording, while keeping the magnetic head staying on one track of the magnetic tape until the magnetic head comes to the physical end of the track. Next, the magnetic head moves to another track, and the tape travels so as to moves across the magnetic head in an inverted direction. This way of recording/reproducing system with the magnetic tape is known as the linear serpentine system.

Japanese Patent Application Publication (KOKAI) 2003-132504, paragraphs [0012]-[0016], discloses a technique making it possible to reproducing narrowly-recorded tracks in the linear tape system, aiming to higher recording density. This technique adopts a multi-reproduction head (referred to as multi-head, hereinafter) making correspondence between a single recording track and a plurality of reproduction heads, wherein the individual reproduction magnetic heads of the multi-head are arranged so as to be shifted in the widthwise direction, and the overall width of the multi-head is made broader than the width of the recording track. This always makes any of the reproduction heads of the multi-head completely scan the recording track, even when the magnetic tape fluctuates relative to the multi-head in the widthwise direction of the track, and this realizes a complete reproduction of magnetic data using so-called, non-tracking reproduction system.

Because the contact area between the magnetic heads and magnetic tape is small in the magnetic tape apparatus based on the serpentine recording/reproducing system, the tape will possibly be damaged only to a lesser degree, and this makes it possible to attain tape running at a high speed. The system is therefore widely used as a magnetic recording/reproducing apparatus for library use, for which high levels of reliability and fastness of rapid recording/reproduction are required.

### SUMMARY OF THE INVENTION

The linear tape system, in which a plurality of tracks are formed in parallel to each other in the longitudinal direction of the magnetic tape, is superior to magnetic recording based on the helical scan system, in that physical load to the traveling magnetic tape is small, and this is preferable for error detection and error correction, but is inferior to the helical scan system in terms of difficulty in the raising the transfer rate. A proposal has therefore been made on a magnetic head device having an interleave structure, forming recording channels at regular intervals in the widthwise direction of the magnetic tape, and providing a plurality of multi-heads corresponding thereto, to thereby make it possible to simultaneously record magnetic signals to tracks of the individual channels.

A problem has, however, arisen in the simultaneous recording of magnetic signals into each of the plurality of recording channels using the multi-heads, in that off-tracking tends to occur due to stretching and shrinkage of the magnetic tape, showing only a poor reliability under increased recording density.

Another problem is that the above-described magnetic head device based on the serpentine system has to keep on positioning the head with respect to data tracks, by keeping on-track state of a servo head onto a servo track. A higher density of the magnetic tape thus requires a larger number of servo heads, and consequently a larger number of servo tracks, and a lager number of data heads. This raises a further problem in that the data tracks are shrunk in the width, therefore the servo heads are shrunk in the width, and also in the intervals, servo signals are degraded in the S/N ratio, and thereby the positioning accuracy degrades.

The present invention is conceived after considering the above-described problems, and an object thereof is to provide a magnetic head device and a magnetic recording/reproducing apparatus capable of attaining higher recording density and higher transfer rate.

In order to solve the above-described problems, the present invention provides a magnetic head device capable of recording magnetic signals simultaneously through a plurality of thin film magnetic heads into a plurality of tracks laid in parallel with a running direction of a magnetic tape. The magnetic head device has “m” pieces of multi-heads spaced from each other by predetermined intervals in a widthwise direction normal to a recording direction of the magnetic tape, each multi-head having “n” pieces of the aforementioned thin film magnetic heads, and the aforementioned “n” pieces of thin film magnetic heads are arranged adjacent to each other so that the individual pairs of magnetic poles of which are shifted in the widthwise direction and running direction of the magnetic tape.

In thus-configured magnetic head device, the individual multi-head can simultaneously record predetermined magnetic signals over a recording channel having a channel width corresponding to a width of the “n” pieces of magnetic poles of the thin film magnetic head at positions spaced by the predetermined intervals on the magnetic tape.

If the “n” pieces of thin film magnetic heads are arranged so as to overlap the adjacent end portions of the individual pairs of magnetic poles thereof, it is made possible to completely expel blank portions, having no magnetic signals recorded therein, from regions between every adjacent tracks.

Provision of a plurality of reproduction magnetic heads detecting recorded magnetic signals also makes it possible to check the recorded magnetic signals to thereby improve recording accuracy.

The present invention also provides a magnetic head device capable of recording or reproducing magnetic signals simultaneously through a plurality of thin film magnetic heads to or from a plurality of tracks laid in parallel with the direction of travel of a magnetic tape, characterized in having a tape feeding unit allowing the magnetic tape to travel, and the “m” pieces of multi-heads spaced from each other by predetermined intervals in the widthwise direction normal to the recording direction of the magnetic tape, each multi-head having the aforementioned “n” pieces of thin film magnetic heads, and the aforementioned “n” pieces of thin film magnetic heads being arranged adjacent to each other so that the individual pairs of magnetic poles of which are shifted in the widthwise direction and feeding direction of the magnetic tape.

By further sequentially shifting the magnetic head device in the widthwise direction of the magnetic tape, so as to scan the plurality tracks for every multi-head, the multi-head can form a serpentine recording pattern by a unit of the plurality of tracks.

The present invention can provide a magnetic head device and a magnetic recording/reproducing apparatus, capable of carrying out an efficient recording to multi-tracks in the linear tape system, and of increasing the recording density and transfer rate.

### BRIEF DESCRIPTION OF THE DRAWINGS

FIG. 1 is a plan view showing a configuration of a magnetic recording/reproducing apparatus according to an embodiment of the present invention;

FIGS. 2A and 2B are plan views showing the configuration of the head surface of the magnetic recording/reproducing apparatus shown in FIG. 1;

FIG. 3 is a plan view showing a part of recording channels formed in a magnetic tape;

FIG. 4 is a plan view showing a recording thin film magnetic head disposed in the multi-head shown in FIGS. 2A and 2B; and

FIG. 5 is a plan view showing a reproducing magnetic head disposed in the multi-head shown in FIGS. 2A and 2B.

### DESCRIPTION OF PREFERRED EMBODIMENTS

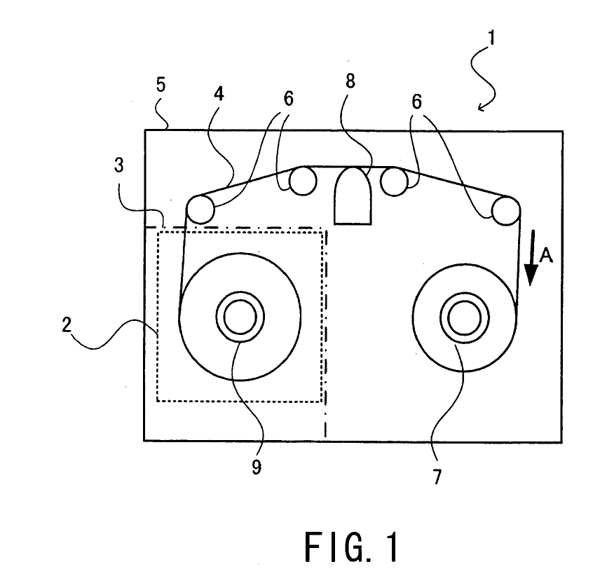

The next paragraphs will detail embodiments of the present invention, referring to the attached drawings. FIG. 1 is a plan view showing a configuration of a magnetic recording/reproducing apparatus of the present invention.

As shown in FIG. 1, a magnetic recording/reproducing apparatus 1 using a magnetic head device of the present invention is a drive apparatus, typically carrying out recording or reproduction to or from a magnetic tape wound in a single-reel-type tape cartridge, and is a magnetic recording/reproducing apparatus based on the linear recording system by which magnetic recording is made in the longitudinal direction of the magnetic tape.

The magnetic recording/reproducing apparatus 1 comprises a cartridge loading section 3 on which a tape cartridge 2 is loaded, a feeding mechanism (not shown) for drawing a magnetic tape 4 loaded on the cartridge loading section 3 out into a main unit 5 of the apparatus and feeding the magnetic tape 4 along a predetermined running route with the aid of guide mechanisms 6, a take-up unit 7 for winding up the magnetic tape 4 fed into the main unit 5, and a magnetic head block 8 for recording or reproducing magnetic signals while being brought into contact, under sliding, with the magnetic tape 4.

In the cartridge loading section 3, although not shown in the figure, there is provided a cartridge loading/unloading slot formed on one side face portion of the main unit 5, and has, formed therein, a loading mechanism which loads or unloads the tape cartridge 2 inserted in the main unit 5. At the loading position of the tape cartridge 2, there is formed a reel drive mechanism rotating a supply reel 9 being housed in the tape cartridge 2 and having the magnetic tape 4 wound therearound although not shown. The loading mechanism carries the tape cartridge 2 inserted through the cartridge loading/unloading slot to the loading position, and makes it engage with the reel drive mechanism. The reel drive mechanism allows the magnetic tape 4 to travel within the main unit 5 by rotating the supply reel 9, and re-winds the magnetic tape 4 delivered into the main unit 5 back on the tape cartridge 2. The loading mechanism carries the tape cartridge 2 from the loading position to the unloading position, when the magnetic tape 4 is wound up into the tape cartridge 2 after completion of recording or reproduction, and ejects it out through the cartridge loading/unloading slot.

The feeding mechanism for feeding the magnetic tape 4 comprises a tape drawing member (not shown) for drawing the magnetic tape 4 out from the tape cartridge 2, and the guide mechanisms 6 for guiding movement of the tape drawing member which drew the magnetic tape 4. The tape drawing member enters the tape cartridge 2 carried to the loading position, engaged with a leader block provided at the end portion of the magnetic tape 4, and draws the magnetic tape 4 out from the tape cartridge 2. The tape drawing member engaged with the end portion of the magnetic tape 4 is guided by the guide mechanisms 6, allows the magnetic tape 4 to contact, under sliding, with the magnetic head block 8 described later, and feeds it to the take-up unit 7 winding up the magnetic tape 4.

The take-up unit 7 has a take-up reel winding up the magnetic tape 4 fed by the feeding mechanism into the main unit 5, and a rotary drive mechanism rotating the take-up reel although not shown in the figure. The take-up reel winds up thereon the magnetic tape 4 under running, while being rotated by the rotary drive mechanism, after the magnetic tape 4 fed by the feeding mechanism is wound up around the take-up unit 7. The magnetic tape 4 is allowed to run in the direction indicated by an arrow “A” in FIG. 1, or in the counter-direction of the arrow “A”, as either of the take-up reel or the supply reel 9 rotates, with the aid of the rotary drive mechanism of the take-up reel, or the reel drive mechanism driving the supply reel 9 provided to the above-described cartridge loading section 3.

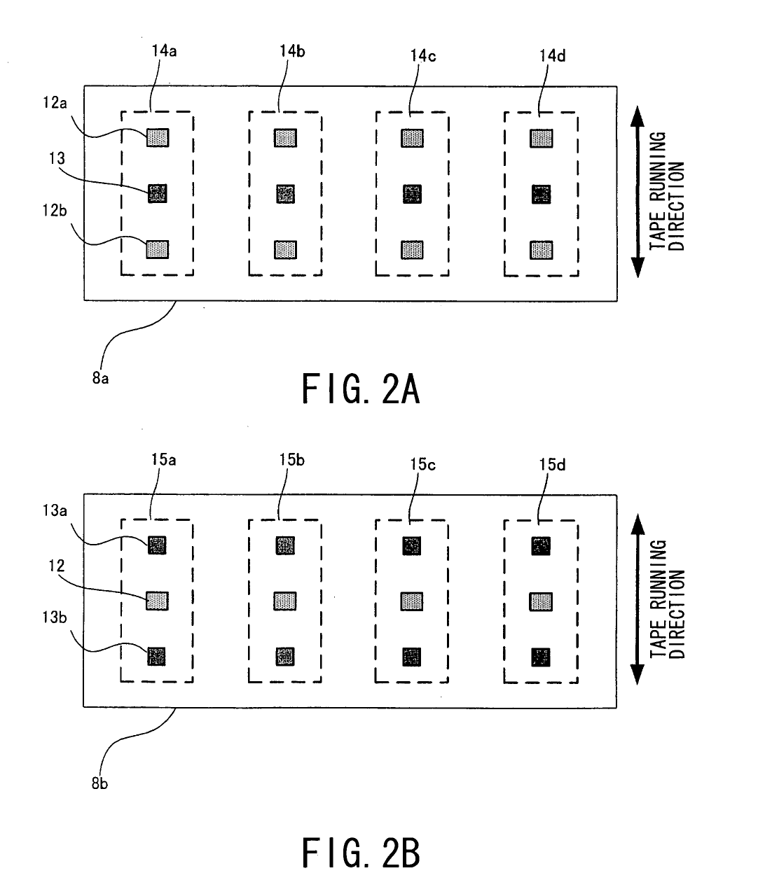

FIGS. 2A and 2B are plan views showing the configuration of the multi-head on a head surface of the magnetic head device in the magnetic recording/reproducing apparatus shown in FIG. 1. The magnetic head block 8 has a head surface effecting the recording and reproduction to or from the magnetic tape running within the main unit 5, and a multi-head exemplified in FIGS. 2A, 2B is capable of recording magnetic signals simultaneously into four recording tacks laid in parallel with the running direction of the magnetic tape.

In a head block 8a shown in FIG. 2A, a multi-head 14a corresponding to one channel is configured by a pair of recording heads 12a, 12b formed in parallel with thee running direction of the magnetic tape 4, and a reproduction head 13 formed between the recording heads 12a, 12b, and “m” pieces of (corresponding to 4 channels in this example) multi-heads 14a to 14d of the same configuration are arranged so as to be spaced from each other by predetermined intervals in the widthwise direction normal to the recording direction of the magnetic tape 4.

In a head block 8b shown in FIG. 2B, a multi-head 15a corresponding to one channel is configured by a pair of reproduction heads 13a, 13b formed in parallel with the running direction of the magnetic tape 4, and a recording head 12 formed between the reproduction heads 13a, 13b, and the multi-heads 15a to 15d corresponding to 4 channels are arranged so as to be spaced from each other by predetermined intervals in the widthwise direction normal to the recording direction of the magnetic tape 4.

The head block 8a is configured so that either ones of the recording heads 12a, 12b of the multi-heads 14a to 14d formed in the widthwise direction are selected depending on the running direction of the magnetic tape 4, so as to make them write data linearly into four recording channels on the magnetic tape 4 in contact therewith under horizontal sliding, and so that, immediately thereafter, the reproduction head 13 detects the recorded magnetic signals to thereby confirm whether the writing was successful or not. On the other hand, the head block 8b is configured so as to make the individual recording heads 12 of the multi-heads 15a to 15d formed in the widthwise direction write data linearly into four recording channels on the magnetic tape 4 in contact therewith under horizontal sliding, and so that, immediately thereafter, either ones of the reproduction heads 13a, 13b are selected depending on the running direction of the magnetic tape 4, so as to make them detect the recorded magnetic signals to thereby confirm whether the writing was successful or not. Both of the head blocks 8a, 8b can therefore conduct so-called, read-after-write, in which the data recorded by the recording heads 12 can immediately be reproduced by the reproduction heads 13, so as to confirm whether the magnetic signals were correctly recorded or not.

This sort of magnetic head block 8 can record magnetic signals into the recording tracks formed over the entire length of the magnetic tape 4, while the magnetic tape 4 travels from the supply reel 9 to the take-up reel. When the magnetic head block 8 reaches the end of the magnetic tape 4, the position of the magnetic head block 8 is shifted so that the individual multi-heads 14 can write data into next recording tracks adjacent in the widthwise direction of the magnetic tape 4. Thereafter, the magnetic tape 4 is then brought into contact therewith under sliding in the inverted direction, and the multi-head 14 can record magnetic signals linearly into another four recording tracks over the entire length of the magnetic tape 4. The following paragraphs will explain the head block 8a configured as shown in FIG. 2A.

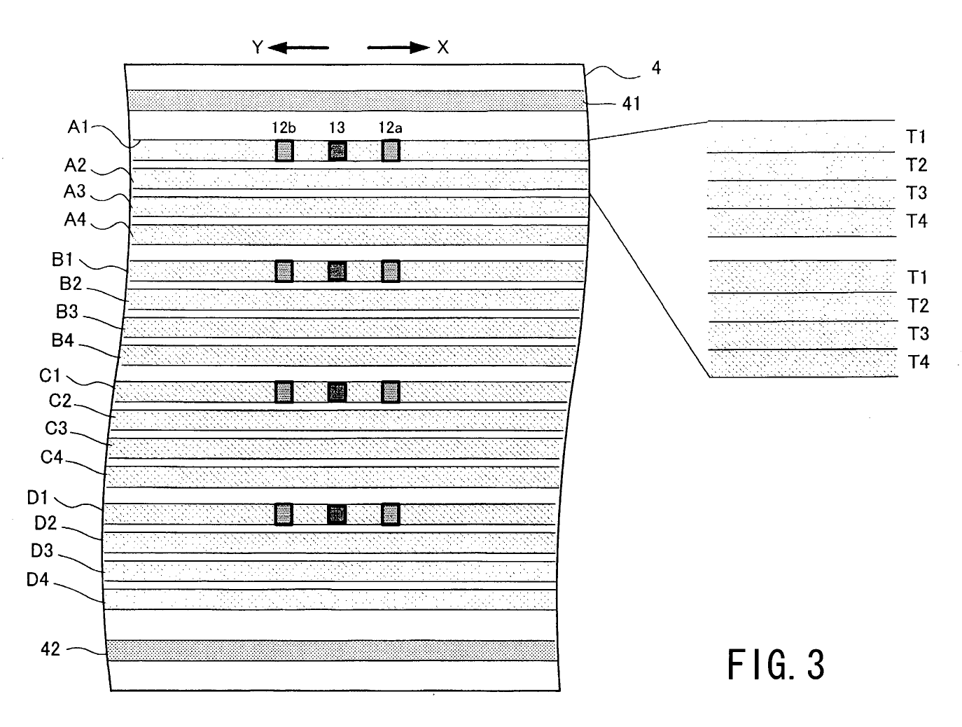

FIG. 3 is a plan view showing a part of the recording channels formed on the magnetic tape. As shown in FIG. 3, the magnetic tape 4 has, on the area in the vicinity of both edges in the widthwise direction thereof, servo patterns 41, 42 for tracking respectively pre-formatted thereon. Between these servo patterns 41, 42, there are formed four sets of recording channels A to D, respectively composed of four physical tracks (A1 to A4, B1 to B4, C1 to C4, and D1 to D4), totals 16 physical tracks. It is to be noted that two out of the recording channels “A” are shown enlarged in the upper right portion of FIG. 3, wherein every physical tracks further comprises four recording tracks T1 to T4.

FIG. 3 shows the recording heads 12a, 12b and the reproduction head 13 composing the multi-heads 14a to 14d shown in FIG. 2A. With these multi-heads 14a to 14d, data are linearly written in four recording tracks A1, B1, C1, and D1 as the magnetic tape 4 travels in the direction indicated by an arrow X in FIG. 3. Upon completion of the data recording into four recording tracks A1, B1, C1, D1 over the entire length of the magnetic tape 4, the multi-head 14 is shifted in the widthwise direction of the magnetic tape 4 so as to be aligned with another four recording tracks, which are A2, B2, C2, D2, for example, the running direction of the magnetic tape 4 is inverted, so as to make it travel in the direction indicated by an arrow Y in FIG. 3, and data are linearly written into the recording tracks A2, B2, C2, D2 at the same time.

Thereafter, every time the recording is completed over the entire length of the magnetic tape 4 and the running direction of the magnetic tape 4 is inverted, the data recording is made effective into the physical tracks formed over the widthwise direction of the magnetic tape 4, in a sequential manner of A1−>A2−>A3−>A4. Also in the head block 8b shown in FIG. 2B, magnetic signals are recorded at the same time into the corresponding recording tracks, with respect to three other channels B to D.

Order of the recording explained in the above was such as A1−>A2−>A3−>A4 sequentially in the widthwise direction of the magnetic tape 4, but the order may also be such as A1−>A3−>A2−>A4, or may even be such as A1−>A4−>A2−>A3.

The multi-head 14 writing data uses “n” (4 for example) pieces of so-called thin film magnetic heads configured by stacking the individual constituents on a substrate by thin film formation techniques as described later. The 4-channel multi-head composed of 4 pieces of thin film magnetic heads can be narrowed in the track width, and can be adapted to further higher density of the magnetic recording medium, because the individual constituents, such as a magnetic core and coil, are formed on the substrate by thin film forming techniques such as plating, sputtering and ion milling.

As described in the above, the magnetic head block 8 having a head surface as shown in FIGS. 2A and B has the multi-heads, corresponded to four channels, over the widthwise direction of the magnetic tape 4, and can simultaneously record magnetic signals into four tracks during a single run of the magnetic tape 4. The high-recording-density design based on use of a single thin film magnetic head having a narrowed width of the magnetic poles is, therefore, advantageous in that it is less causative of off-tracking even if stretching/shrinkage or variable travel speed of the magnetic tape should occur, and in that the recording accuracy and reliability are improved as compared with a related art apparatus in which a plurality of tracks are sequentially subjected to on-track control only by a mechanical positional control.

Recording/reproduction of magnetic signals are generally accompanied with error, so that magnetic signals including a digital image signal, a digital audio signal and a sub-code have an error correction code encoded therein. One known error correction code is a product code capable of effecting encoding using separate error correction codes in the row (horizontal) direction and column (vertical) direction of a matrix-formed data arrangement. The product code, having the individual data symbols belonging to two error correction code series, is known to be excellent in the error correction ability.

Digital VTR, adopting the segment system, records PCM (pulse code modulation) audio signals for a single field into a plurality of tracks in a distributed manner. The PCM audio signals in the individual tracks are encoded using the above-described product code. However, too much error cannot completely be corrected by the error correction code. In this case, the error data are corrected so as to make them not so noisy. For example, the error sample is replaced with a mean value of correct samples before and after the error sample, which is known as mean-value interpolation.

For more efficient error correction, a process called interleaving is carried out, in which recording positions of successive samples in PCM audio signal series are spaced. In this way, the above-described magnetic head device can interleave data to a plurality tracks and add the error correction codes, wherein the error correction codes are interleaved to the tracks in the number integer multiple, or an integer fraction, of the number of the multi-heads. It is therefore made possible, even if all data strings in one track are judged as errors, to correct these errors based on data strings in other tracks, and to reproduce them.

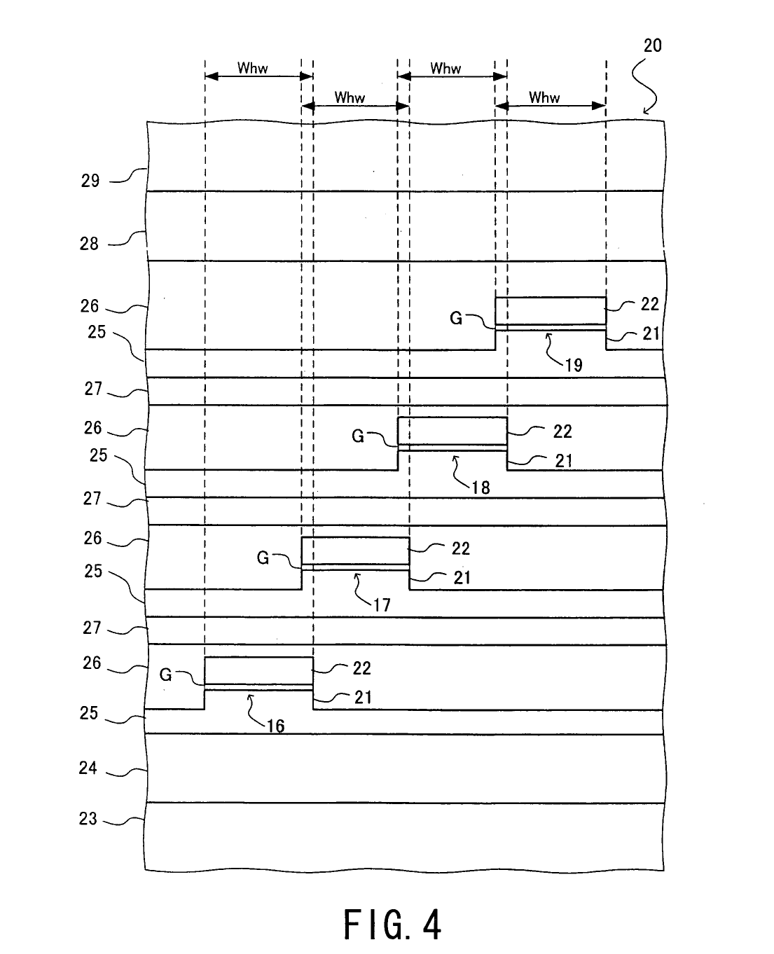

FIG. 4 is a plan view showing a thin film magnetic head for recording use, disposed on the multi-head shown in FIGS. 2A and 2B. FIG. 4 shows a configuration of a thin film magnetic head 20 for recording use, on which “n” (4, for example) pieces of thin film magnetic heads 16 to 19 are arranged so as to be shifted in a direction normal to the gap direction, and so as to overlap the adjacent end portions of the individual pairs of magnetic poles. The thin film magnetic head 20 for recording use is configured as an inductive-type, multi-head in which the thin film magnetic heads 16 to 19, each of which having a pair of magnetic cores 21, 22, both being composed of a soft magnetic material, bonded while placing a magnetic gap G composed of a non-magnetic material in between, and having unillustrated coils wound around the magnetic cores 21, 22, are formed on a ceramic substrate 23 such as Altic (Al₂O₃TiC), as being integrated therewith.

In one specific configuration of the thin film magnetic head 16, an insulating layer composed of a first magnetic head member 24 is disposed on the ceramic substrate 23, and thereon, a lower pole 25 configuring the magnetic core 21 to a predetermined width is disposed. On the lower pole 25, an insulating layer 26 is formed using SiO₂ or a thermally-cured photoresist, the unillustrated coil is formed, and the magnetic core 22 which serves as an upper pole is formed while placing a predetermined gap G thereunder.

The next thin film magnetic head 17 is configured, while placing an insulating layer composed of a second magnetic head member 27, so that a pair of magnetic cores 21, 22 are similarly formed in a predetermined region of the lower pole 25 and the insulating layer 26. The same will apply also to the thin film magnetic heads 18, 19, so that they will not be explained, wherein the thin film magnetic head 20 for recording use has, on the topmost layer thereof, a ceramic substrate 29 while placing an insulating layer 28 thereunder.

As has been described in the above, the region where each of the thin film magnetic heads 16 to 19 is formed ranges only partially in a direction normal to the direction of stacking of them, and the other portions in the same level in the direction of stacking are respectively protected by a non-magnetic material.

The magnetic cores 21, 22, the magnetic head member 24 and the lower pole 25 are composed of high magnetic materials, preferable examples of which includes Ni—Fe (Permalloy), Si—Al—Fe (Sendust), and amorphous iron core material (high permeability thin strip).

Each of the thin film magnetic heads 16 to 19 are shifted in the direction of stacking, so that the coils thereof will never interfere with each other. It is therefore made possible to dispose the individual thin film magnetic heads 16 to 19 with arbitrary positional relations in the direction (widthwise direction) normal to the direction of stacking.

In this magnetic head device, the individual thin film magnetic heads 16 to 19 are arranged so as to be shifted in the widthwise direction of the recording channels, and so that the adjacent end portions of the pairs of magnetic poles are respectively overlapped when viewed from the direction of stacking, so that the formation pitch of the individual thin film magnetic heads 16 to 19 is made smaller than the magnetic pole width Whw of the individual thin film magnetic heads 16 to 19. The magnetic pole width Whw of the individual pairs of magnetic pole 15 is typically adjusted to 1.2 μm, and the formation pitch is adjusted to 1.0 μm.

In information recording to a magnetic tape which travels in contact with, or in close proximity of the thin film magnetic head 20 for recording use, first, the recording track T1 having a track width equal to the magnetic pole width Whw=1.2 μm is formed by the first thin film magnetic head 16, and then the recording track T2 having a track width of 1.2 μm is formed by the second thin film magnetic head 17, making an overlap of 0.2 μm therebetween. This consequently makes all track widths, except that of the recording track T4 formed last, have a width of W=1.0 μm, making it possible to form narrower recording tracks Tr.

Thus-configured thin film magnetic head 20 for recording, having thin film magnetic heads 16 to 19 provided in a plurality (multiple) of numbers, but arranged so as to be overlapped in the widthwise direction of the individual pairs of magnetic poles, allows overwrite operation by the adjacent recording tracks T1 to T4, and this makes it possible to narrow the individual track pitch as compared with the actual magnetic pole width of the thin film magnetic heads 16 to 19, contributing to higher recording density.

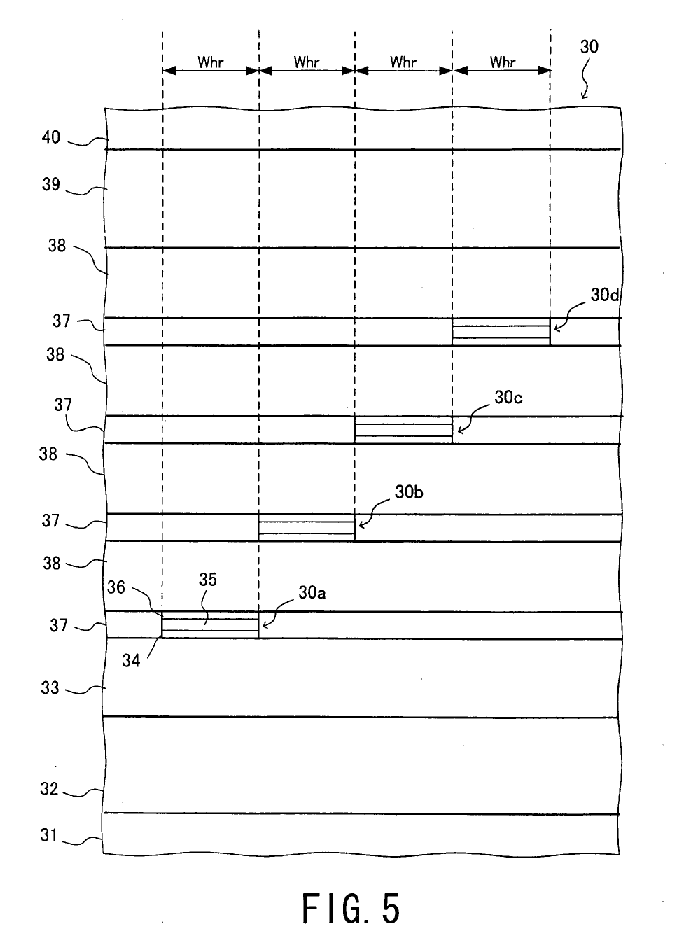

FIG. 5 is a plan view showing reproduction magnetic heads arranged on the multi-head shown in FIGS. 2A and 2B. The paragraphs below will explain a reproduction magnetic head 30 having four vertical MR thin film heads 30a to 30d stacked therein. A soft magnetic film (SAL film), which serves as a lower shield magnetic material 33, and a lower gap insulating layer 34 are stacked in this order on a non-magnetic substrate, while placing an insulating layer 32 in between, and on the lower gap insulating layer 34, an MR element 35 is arranged so as to direct its longitudinal direction normal to the head surface which is an opposing surface to a magnetic tape, and so as to expose one end surface thereof to the head surface. A magnetic sensitive portion which determines reproduction width Whr of the MR thin film head 30a is configured by the MR element 35 and the lower shield magnetic material 33 (SAL film) respectively as being held between thin non-magnetic layers. The MR element 35 has, on both ends thereof, a front end electrode and a rear end electrode, both of which not shown, for providing sense current.

Thereafter, an insulating layer 36 is stacked over the entire surface of the MR element 35 including the front end electrode and rear end electrode, and a hard film 37 for bias use is formed on both sides of the MR element 35, while placing a non-magnetic layer in between in the longitudinal direction, although not shown, to thereby configure an MR thin film head 30a. A soft magnetic films, which serves as a lower shield magnetic material 38 for an MR thin film head 30b in the next is stacked over the entire surface, to thereby configure MR thin film heads 30b, 30c, 30d. On the topmost layer of the reproduction magnetic head 30, there is disposed a non-magnetic substrate 40 while placing an insulating layer 39 in between.

Thus-configured reproduction magnetic heads 30, each of which corresponding to the reproduction head 13 in the magnetic head block 8 shown in FIGS. 2A and 2B, are arranged for four channels, and can read information simultaneously from a plurality of tracks on the magnetic tape 4 having magnetic signals recorded therein, by changing the resistivity value of the MR elements 35 depending on changes in the recorded magnetic field of the magnetic tape.

It is also allowable to arrange the MR thin film heads 30a to 30d for four channels so that the individual MR elements 35 are overlapped at the adjacent end portions, at intervals narrower than the reproduction width Whr.

It is still also allowable to configure the reproduction magnetic head 30 by using “2n” or more pieces of MR elements 35 each having a reproduction width Whr not larger than half of the magnetic pole width Whw of the thin film magnetic heads 16 to 19. The individual recording tracks in this configuration can be scanned by one or more MR elements 35, so that it is made possible to more accurately read recorded signals even when the magnetic tape fluctuates in the direction of the track width relative to the reproduction magnetic head 30.

It should be understood by those skilled in the art that various modifications, combinations, sub-combinations and alterations may occur depending on design requirements and other factors insofar as they are within the scope of the appended claims or the equivalents thereof.

1. A magnetic head device which records magnetic signals simultaneously through a plurality of thin film magnetic heads into a plurality of tracks laid in parallel with a running direction of a magnetic tape, said magnetic head device comprising:
m-pieces of multi-heads spaced from each other by predetermined intervals in a widthwise direction normal to a recording direction of said magnetic tape, each multi-head having n-pieces of said thin film magnetic heads, wherein:
said n-pieces of thin film magnetic heads are arranged adjacent to each other so that a pair of magnetic poles of which are shifted on a head surface of each of said multi-heads in the widthwise direction and the running direction of said magnetic tape.

2. The magnetic head device as claimed in claim 1, wherein:
each of said multi-heads records predetermined magnetic signals over a recording channel having a channel width corresponding to a magnetic pole width of said n-pieces of thin film magnetic heads at positions spaced by said predetermined intervals on said magnetic tape.

3. The magnetic head device as claimed in claim 1, wherein:
each of said multi-heads is configured so that n-pieces of said thin film magnetic head are disposed to overlap at adjacent end portions of each pair of magnetic poles.

4. The magnetic head device as claimed in claim 1, wherein:
each of said multi-heads further has a plurality of reproduction magnetic heads detecting a recorded magnetic signal.

5. The magnetic head device as claimed in claim 4, wherein:
each of said multi-heads has two sets of n-pieces of said thin film magnetic head having said pair of magnetic poles shifted in the widthwise direction and the running direction of said magnetic tape to be adjacently arranged and n-pieces of said reproduction magnetic heads, and
each of n-pieces of said thin film magnetic heads is arranged before and after said reproduction magnetic head in the running direction of said magnetic tape on a head surface of each of said multi-heads.

6. The magnetic head device as claimed in claim 4, wherein said reproduction magnetic head is configured to have 2n or more pieces of MR elements having a reproduction width half or less than half of a magnetic pole width of said thin film magnetic head, each shifted in the widthwise direction of said magnetic tape.

7. The magnetic head device as claimed in claim 1, wherein:
each of said multi-heads has a reproduction magnetic head in addition to said n-pieces of thin film magnetic heads,
on a head surface of each of said multi-heads, said reproduction head is arranged before and after each of said n-pieces of thin film magnetic heads in the running direction of said magnetic tape.

8. The magnetic head device as claimed in claim 7, wherein said reproduction magnetic head is configured to have 2n or more pieces of MR elements having a reproduction width half or less than half of a magnetic pole width of said thin film magnetic head, each shifted in the widthwise direction of said magnetic tape.

9. A magnetic recording/reproducing apparatus which records and reproduces magnetic signals simultaneously through a plurality of thin film magnetic heads into a plurality of tracks laid in parallel with a running direction of a magnetic tape, said magnetic head device comprising:
tape running means allowing said magnetic tape to run; and
m-pieces of multi-heads spaced from each other by predetermined intervals in a widthwise direction normal to a recording direction of said magnetic tape, each multi-head having n-pieces of said thin film magnetic heads, wherein:
said n-pieces of thin film magnetic heads are arranged adjacent to each other so that the individual pairs of magnetic poles of which are shifted on a head surface of each of said multi-heads in the widthwise direction and the running direction of said magnetic tape.

10. The magnetic recording/reproducing apparatus as claimed in claim 9, wherein said multi-heads form a serpentine recording pattern by a unit of said plurality of tracks by sequentially shifting said magnetic head device in the widthwise direction of said magnetic tape so as to scan said plurality tracks for every multi-head.

11. The magnetic recording/reproducing apparatus as claimed in claim 10, wherein each of said multi-heads further has a plurality of reproduction magnetic heads detecting a magnetic signal recorded on said magnetic tape.
